(19) United States
(12) Patent Application Publication
(10) Pub. No.: US 2025/0239726 A1
(43) Pub. Date: Jul. 24, 2025

(54) ENERGY STORAGE SYSTEM

(71) Applicant: SAMSUNG SDI CO., LTD., Yongin-si (KR)

(72) Inventors: Jae Soon KIM, Suwon-si (KR); Eun Ok KWAK, Suwon-si (KR)

(21) Appl. No.: 18/827,273

(22) Filed: Sep. 6, 2024

(30) Foreign Application Priority Data
Jan. 19, 2024 (KR) 10-2024-0008594

(51) Int. Cl. H01M 50/383; H01M 10/48; H01M 50/317

(52) U.S. Cl. CPC H01M 50/383; H01M 10/486; H01M 50/317; H01M 2200/20

(57) ABSTRACT

An energy storage system according to one or more embodiments of the present disclosure includes: a container configured to accommodate a battery rack; a hood comprising a vent connected with an internal space of the container; an opening/closing member that is installed in the hood and opens or closes the vent; and a fire extinguishing unit outside the container that sprays a fire extinguishing liquid toward the vent as the opening/closing member opens the vent.

### CROSS-REFERENCE TO RELATED APPLICATION

The present application claims priority to and the benefit of Korean Patent Application No. 10-2024-0008594, filed on Jan. 19, 2024, the entire disclosure of which is incorporated herein by reference.

### BACKGROUND

### 1. Field

Aspects of embodiments of the present disclosure relates to an energy storage system.

### 2. Discussion of Related Art

Generally, an energy storage system (ESS) is a device that can store surplus electricity or store electricity produced using renewable energy. An ESS may be configured by installing a plurality of battery modules in racks and accommodating a plurality of the racks in a container. A battery module may be constructed by assembling a plurality of secondary batteries, which are electrically connected to each other, in various structures.

In such an ESS, in the event of a fire due to thermal runaway that occurs during the charging and discharging process of secondary batteries or other electrical defects, there is a risk that some or all components inside a container may be exposed to the fire and be burned completely or damaged by the fire. In order to prevent the above risk, fire prevention compartments may be built by erecting an impermeable firewall in the middle of the container. However, in this case, separate air conditioning equipment is required for each compartment, which increases costs and is disadvantageous in terms of battery energy density.

The above-described information disclosed in the technology that forms the background of the present disclosure is only intended to improve understanding of the background of the present disclosure, and thus may include information that does not constitute the prior art or related art.

### SUMMARY

The present disclosure is directed to providing an energy storage system that can prevent or reduce direct exposure to a fire of a fire extinguishing system.

These and other aspects and features of the present disclosure will be described in or will be apparent from the following description of some embodiments of the present disclosure.

According to some embodiments of the disclosure, there is provided an energy storage system including: a container configured to accommodate a battery rack; a hood including a vent connected with an internal space of the container; an opening/closing member that is installed in the hood and opens or closes the vent; and a fire extinguishing unit outside the container that sprays a fire extinguishing liquid toward the vent as the opening/closing member opens the vent.

In some embodiments, the opening/closing member may open or close the vent in response to an internal pressure of the container.

In some embodiments, the opening/closing member may include: a blocking panel disposed to block the vent; a fixed portion that is on one side of the blocking panel and fixed to the hood; and a separated portion that is on another side of the blocking panel and separably connected to the hood, and the separated portion may be separated from the hood as a pressure of a preset magnitude or more is applied to the blocking panel.

In some embodiments, the fixed portion and the separated portion may surround a perimeter of the blocking panel, and a length of the separated portion may be longer than a length of the fixed portion.

In some embodiments, the blocking panel may be rotated about the fixed portion as the separated portion is separated from the hood.

6. The energy storage system as claimed in claim 5, wherein the fire extinguishing unit may include: a supply unit that supplies fire extinguishing liquid; a transfer pipe that is connected to the supply unit and transfers the fire extinguishing liquid supplied from the supply unit; and a spray nozzle that extends from the transfer pipe and faces the vent.

In some embodiments, the hood and the spray nozzle may be provided as a plurality of hoods and a plurality of spray nozzles, respectively, and the plurality of spray nozzles may face the plurality of hoods, respectively.

In some embodiments, the spray nozzle may be outside a rotation path of the blocking panel.

In some embodiments, the separated portion may include: a first broken end area facing the fixed portion; a second broken end area that is connected to one end portion of the fixed portion and one end portion of the first broken end area; and a third broken end area that is connected to the other end portion of the fixed portion and the other end portion of the first broken end area, and the spray nozzle may be spaced apart from the fixed portion with the first broken end area interposed therebetween.

In some embodiments, the spray nozzle may face an inner surface of the blocking panel when the blocking panel opens the vent.

In some embodiments, a distance from the container to the spray nozzle may be greater than a distance from the container to an end portion of the hood, and the end portion of the spray nozzle may extend obliquely toward the vent.

In some embodiments, the spray nozzle may adjust a spray direction of the fire extinguishing liquid.

In some embodiments, the energy storage system may further include: a detection unit configured to detect opening or closing of the vent; and a control unit configured to determine whether the vent is opened or closed on the basis of data detected by the detection unit, and operate the fire extinguishing unit to spray the fire extinguishing liquid to the vent if it is determined that the vent is opened.

In some embodiments, the detection unit may include at least one of the following: a position sensor that detects a position of the opening/closing member; a flame sensor that detects flame discharged from the vent; or a smoke sensor that detects smoke discharged from the vent.

In some embodiments, the hood may be provided as a plurality of hoods, and the control unit individually may determine whether a plurality of vents are opened or closed, and may control an operation of the fire extinguishing unit so that the fire extinguishing liquid is sprayed only to a vent that is opened among the plurality of vents.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

The above and other objects, features and advantages of the present disclosure will become more apparent to those of ordinary skill in the art by describing exemplary embodiments thereof in detail with reference to the accompanying drawings, in which:

FIG. 1 is a perspective view schematically illustrating a configuration of an energy storage system according to some embodiments of the present disclosure;

FIG. 2 is a perspective view schematically illustrating vents in FIG. 1 in an open state;

FIG. 3 is a plan view schematically illustrating the configuration of the energy storage system according to some embodiments of the present disclosure;

FIG. 4 is a side view schematically illustrating the configuration of the energy storage system according to some embodiments of the present disclosure;

FIG. 5 is an enlarged view schematically illustrating a state in which an opening/closing member closes a vent according to some embodiments of the present disclosure;

FIG. 6 is an enlarged view schematically illustrating a state in which the opening/closing member opens the vent according to some embodiments of the present disclosure;

FIG. 7 is an enlarged view schematically illustrating a configuration of a spray nozzle according to some embodiments of the present disclosure;

FIGS. 8 to 10 are views schematically illustrating an operation process of the energy storage system according to some embodiments of the present disclosure;

FIG. 11 is a perspective view schematically illustrating a configuration of an energy storage system according to some embodiments of the present disclosure;

FIG. 12 is a block diagram schematically illustrating the configuration of the energy storage system according to some embodiments of the present disclosure; and

FIG. 13 is a view schematically illustrating an operation state of the energy storage system according to some embodiments of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

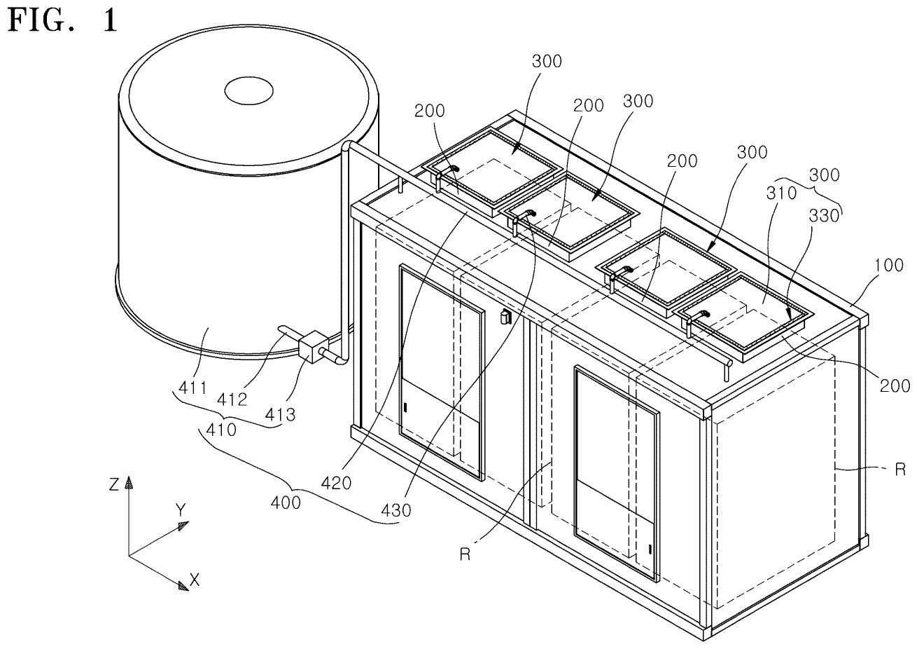

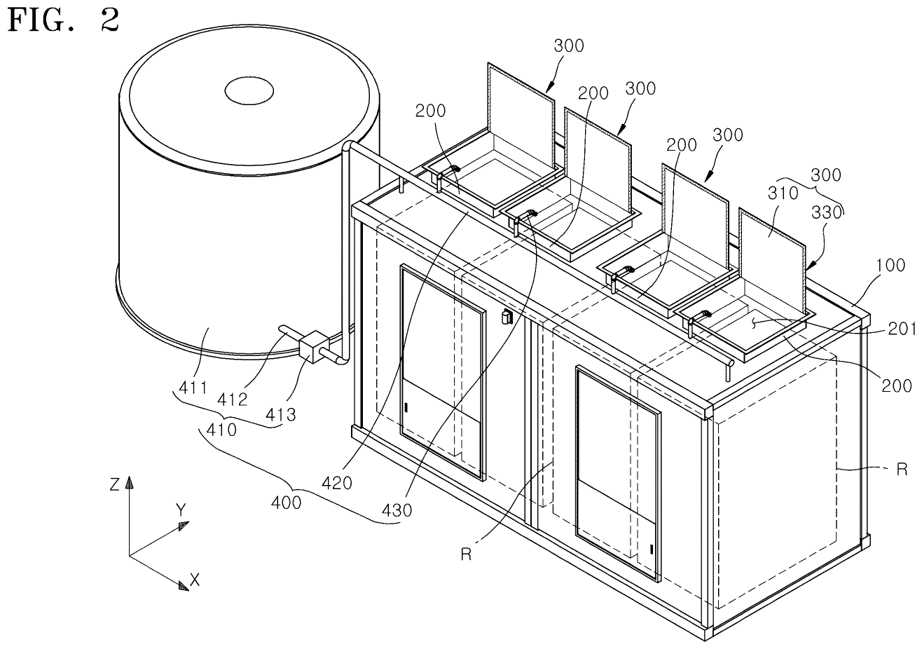

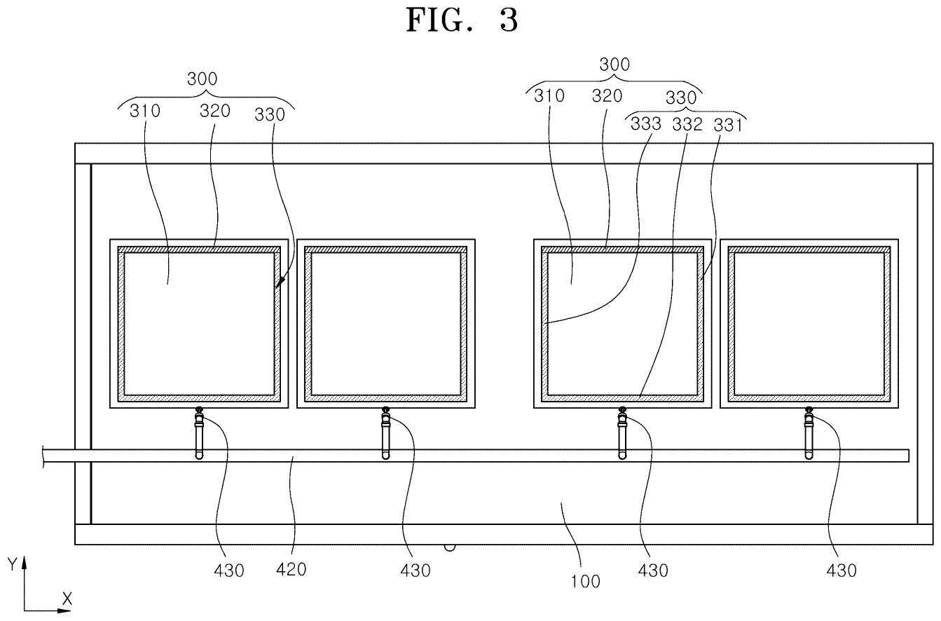

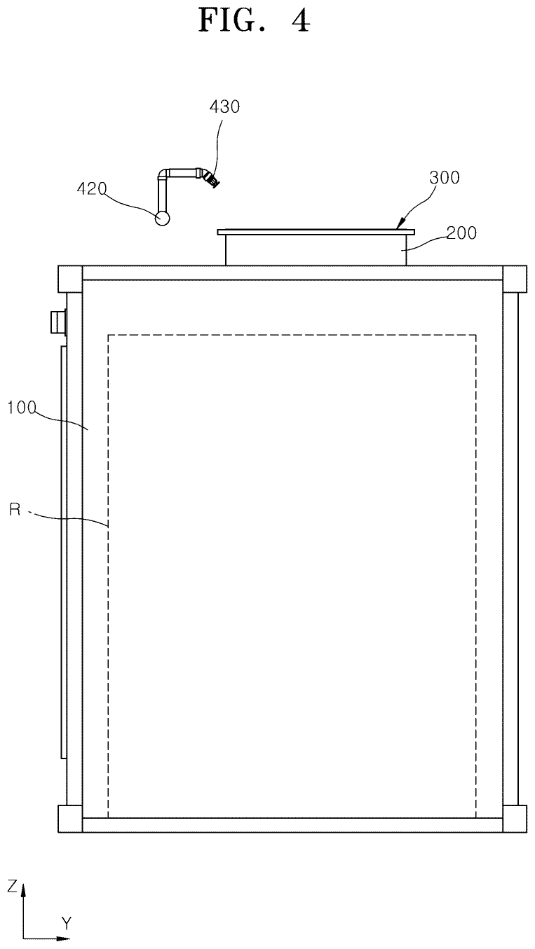

FIG. 1 is a perspective view schematically illustrating a configuration of an energy storage system according to some embodiments of the present disclosure. FIG. 2 is a perspective view schematically illustrating vents in FIG. 1 in an open state. FIG. 3 is a plan view schematically illustrating the configuration of the energy storage system according to some embodiments of the present disclosure. FIG. 4 is a side view schematically illustrating the configuration of the energy storage system according to some embodiments of the present disclosure.

Referring to FIGS. 1 to 4, the energy storage system according to some embodiments includes a container 100, a hood 200, an opening/closing member 300, and a fire extinguishing unit 400.

The container 100 forms a schematic appearance of the energy storage system. Examples of the container 100 may include various types of closed structures with an empty interior, such as a stand-alone building, a room within a building, a container, etc. The design of the shape of the container 100 may be changed to various suitable shapes, such as a polyhedral shape, a cylindrical shape, etc., in addition to a rectangular parallelepiped shape illustrated in FIG. 1.

A battery rack R for storing power may be accommodated inside the container 100. The battery rack R may include a battery module including a plurality of battery cells that stores power through charging and discharging operations or supplies the stored power to external electronic devices. The battery rack R may include a rack frame that supports the battery module. A plurality of battery modules may be stored in the rack frame in a plurality of columns in an X-axis direction and a Z-axis direction with respect to FIG. 1.

The battery rack R may be provided as a plurality of battery racks R. The plurality of battery racks R may be disposed to be spaced apart from each other inside the container. As illustrated in FIG. 1, the plurality of battery racks R may be arranged in a row, or alternatively, the plurality of battery racks R may be arranged in a lattice form.

The hood 200 is provided on the container 100. The hood 200 provides a path through which smoke, gas, flame, and the like, generated due to a fire in the battery racks R can be discharged from the interior of the container 100 and a path through which fire extinguishing liquid sprayed from the fire extinguishing unit 400, which will be described below, can be introduced into the interior of (e.g., enter) the container 100.

The hood 200 according to some embodiments may be formed to have the shape of a pillar extending from an outer surface of the container 100 toward the outside of the container 100. The hood 200 may be provided as a plurality of hoods 200. The plurality of hoods 200 may be disposed on an upper side of the container 100 and arranged in the X-axis direction with respect to FIG. 1 on the container 100. The plurality of hoods 200 may be disposed at positions facing the respective battery racks R. The positions of the plurality of hoods 200 are not limited to the above description, and the design thereof may be changed to various positions.

A vent 201 connect with an internal space of the container 100 may be formed in the hood 200. The vent 201 may be formed to have the shape of a hole formed to pass through the hood 200. The vent 201 may pass through the hood 200 in a vertical direction, that is, a direction parallel to the Z-axis with respect to FIG. 1. A lower end portion of the vent 201 may connect with the internal space of the container 100, and an upper end portion of the vent 201 may connect with an external space of the container 100. The design of a cross-sectional shape of the vent 201 may be changed to various shapes, such as a polygonal shape, a circular shape, and an elliptical shape, in addition to the quadrilateral shape illustrated in FIG. 2.

In the above, the hood 200 has been described as an example of having the shape of a pillar extending from the container 100, but the hood 200 is not limited thereto, and may be an outer surface of the container 100 that surrounds a periphery of the vent 201.

The opening/closing member 300 is installed on the hood 200 and opens or closes the vent 201. The opening/closing member 300 may open or close the vent 201 in response to an internal pressure of the container 100. More specifically, the opening/closing member 300 may keep the vent 201 closed in normal time, and may open the vent 201 when the internal pressure of the container 100 increases to a set magnitude or more due to a fire or the like in the battery rack R. Accordingly, the opening/closing member 300 may prevent foreign substances or the like from being introduced into the interior of the container 100 in normal time, and prevent the explosion of the container 100 caused by an increase in pressure in the event of a fire.

The opening/closing member 300 may be provided as a plurality of opening/closing members 300. The plurality of opening/closing members 300 may be installed to independently open or close different vents 201 formed in the respective hoods 200.

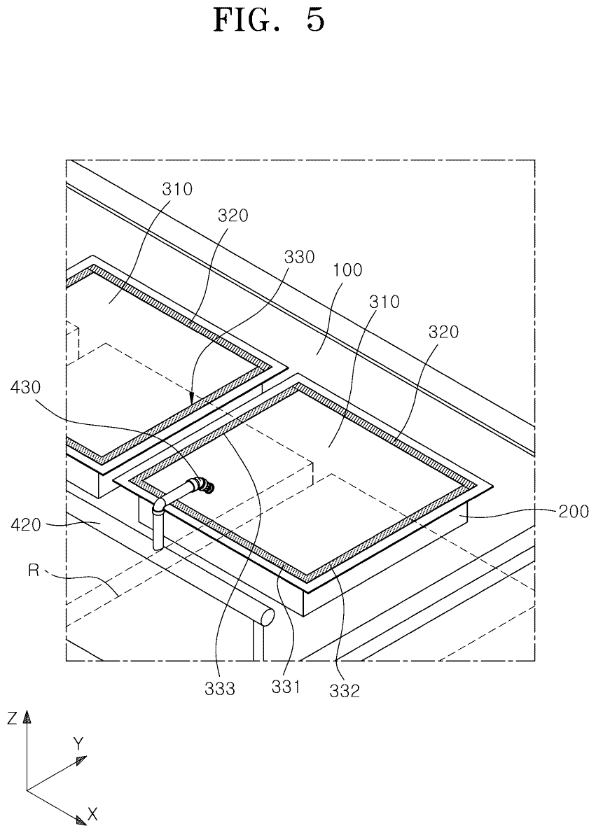

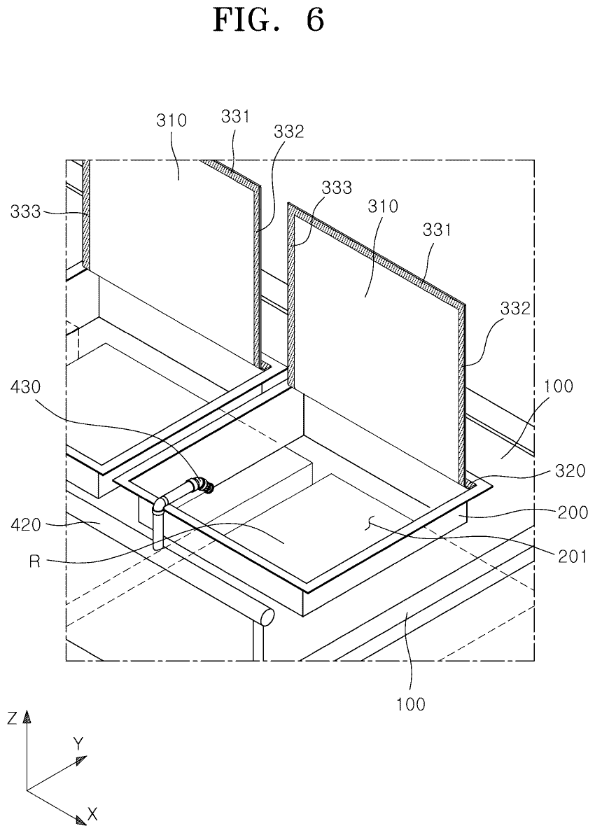

FIG. 5 is an enlarged view schematically illustrating a state in which the opening/closing member closes the vent according to some embodiments of the present disclosure, and FIG. 6 is an enlarged view schematically illustrating a state in which the opening/closing member opens the vent according to some embodiments of the present disclosure.

Referring to FIGS. 5 and 6, the opening/closing member 300 according to some embodiments may include a blocking panel 310, a fixed portion 320, and a separated portion 330.

The blocking panel 310 may be formed to have a substantially flat plate shape and may be disposed to block the vent 201. More specifically, an inner surface of the blocking panel 310 may be disposed to face the vent 201 in an extension direction of the hood 200 and may block a gas moving path through the vent 201. The blocking panel 310 may be disposed on an upper end portion of the hood 200 as illustrated in FIGS. 5 and 6, or alternatively, the blocking panel 310 may be disposed inside the hood 200. The blocking panel 310 may be made of a metal material to prevent damage from external foreign substances, impacts, etc. The design in respect to a thickness of the blocking panel 310 may be changed in various suitable ways depending on the material of the blocking panel 310, the magnitude of the internal pressure of the container 100, etc. A cross-sectional shape of the blocking panel 310 is not limited to a quadrilateral shape illustrated in FIG. 5, and the design thereof may be changed in various suitable ways depending on a cross-sectional shape of the vent 201.

The fixed portion 320 is disposed on one side of the blocking panel 310 and is fixed to the hood 200. Examples of the fixed portion 320 according to some embodiments may include some or all edge areas of the blocking panel 310 surrounding a perimeter of the blocking panel 310. A lower surface of the fixed portion 320 may be in contact with the upper end portion of the hood 200, and may be fixed to the upper end portion of the hood 200 by various coupling methods, such as welding, bolting, fitting, etc. Alternatively, the fixed portion 320 may be disposed inside the hood 200, and a side surface thereof may be fixed to an inner surface of the hood 200.

The separated portion 330 may be disposed on another side of the blocking panel 310 and may be connected to the hood 200 to be separable. Examples of the separated portion 330 according to some embodiments may include remaining areas excluding the fixed portion 320 among all the edge areas of the blocking panel 310 surrounding the perimeter of the blocking panel 310. The separated portion 330 and the fixed portion 320 may form a closed curve that continuously extends in the perimeter of the blocking panel 310. For example, the separated portion 330 may include: a first broken end area 331 disposed to face the fixed portion 320 in a width direction of the hood 200, a second broken end area 332 connected to one end portion of the first broken end area 331 and one end portion of the fixed portion 320, and a third broken end area 333 connected to the other end portion of the first broken end area 331 and the other end portion of the fixed portion 320. The blocking panel 310 may have a substantially quadrilateral cross-section, and thus the first broken end area 331, the second broken end area 332, and the third broken end area 333 may be disposed to form a substantially rectangular shape without one side.

A lower surface of the separated portion 330 may be in contact with the upper end portion of the hood 200, and may be fixed to the upper end portion of the hood 200 by various coupling methods such as welding, bolting, fitting, etc. Alternatively, the separated portion 330 may be disposed inside the hood 200, and a side surface thereof may be fixed to the inner surface of the hood 200.

The separated portion 330 may be separated from the hood 200 when a pressure of a set magnitude or more is applied to the blocking panel 310 (e.g., an outward pressure). Here, the design of the magnitude of the pressure at which the separated portion 330 is separated from the hood 200 may be changed in various ways within a range of the pressure applied to the blocking panel 310 when a fire occurs inside the container 100. To this end, a coupling force between the separated portion 330 and the hood 200 may be smaller than a coupling force between the fixed portion 320 and the hood 200. More specifically, based on the set pressure applied to the blocking panel 310, the coupling force between the separated portion 330 and the hood 200 may be smaller than the set pressure, and the coupling force between the fixed portion 320 and the hood 200 may be greater than the set pressure. When the fixed portion 320 and the separated portion 330 are coupled to the hood 200 by welding, the difference in coupling force may be realized in various ways. For example, a welding length between the separated portion 330 and the hood 200 may be shorter than a welding length between the fixed portion 320 and the hood 200, a number of welding points between the separated portion 330 and the hood 200 may be smaller than a number of welding points between the fixed portion 320 and the hood 200, or a welding material between the separated portion 330 and the hood 200 may have a smaller strength than a welding material between the fixed portion 320 and the hood 200.

As illustrated in FIG. 6, as the separated portion 330 is separated from the hood 200, the blocking panel 310 may be rotated about the fixed portion 320 in a direction toward the outside of the container 100 and may open the vent 201. In this case, the blocking panel 310 may be bent and deformed based on a boundary line with the fixed portion 320 and may be hinged in the direction toward the outside of the container 100.

A length of the separated portion 330 may be longer than a length of the fixed portion 320. That is, the sum of the lengths of the first broken end area 331, the second broken end area 332, and the third broken end area 333 may be greater than the length of the fixed portion 320. Accordingly, when the pressure of the set magnitude is applied to the blocking panel 310, the opening/closing member 300 may further expand an open area of the vent 201 by ensuring that an area separated from the hood 200 is greater than the area fixed to the hood 200.

As illustrated in FIG. 1 and FIGS. 5-6, The fire extinguishing unit 400 sprays the fire extinguishing liquid toward the vent 201 when the opening/closing member 300 opens the vent 201. That is, the fire extinguishing unit 400 may serve as a component that extinguishes a fire by directly spraying the fire extinguishing liquid into the container 100 through the vent 201 when the opening/closing member 300 is opened due to a fire occurring inside the container 100. The fire extinguishing unit 400 may be disposed outside the container 100 so as not to be directly exposed to a flame or smoke when a fire occurs inside the container 100. Accordingly, the fire extinguishing unit 400 may prevent damage due to heat or the like, and thus, the reliability of fire suppression can be improved.

The fire extinguishing unit 400 according to some embodiments may include a supply unit 410, a transfer pipe 420, and a spray nozzle 430.

The supply unit 410 supplies fire extinguishing liquid to the transfer pipe 420, which will be described below. The supply unit 410 according to some embodiments may include a storage tank 411 for storing the fire extinguishing liquid, a supply pipe 412 connected to the storage tank 411, and a supply valve 413 that allows or blocks the movement of the fire extinguishing liquid through the supply pipe 412. The supply valve 413 may be a manual valve that opens or closes the supply pipe 412 by the worker's handle operation and the like, or alternatively, the supply valve 413 may be an electric valve that automatically opens or closes the supply pipe 412 by an electrical signal applied from the outside. A pump that receives power from the outside and provides flow force to the fire extinguishing liquid moving through the supply pipe 412 may be additionally installed in the supply pipe 412.

The transfer pipe 420 is connected to the supply unit 410 and transfers the fire extinguishing liquid supplied from the supply unit 410. The transfer pipe 420 may be formed to have the shape of a pipe with an empty interior. One end portion of the transfer pipe 420 may be connected to the supply pipe 412, and the transfer pipe 420 may receive the fire extinguishing liquid stored in the storage tank 411 through the supply pipe 412.

The transfer pipe 420 may be disposed to be spaced apart from the container 100. For example, the transfer pipe 420 may be disposed to face an upper surface of the container 100 to be spaced a predetermined (e.g., set or preset) interval from the upper surface of the container 100. The transfer pipe 420 may extend in a direction in which the plurality of hoods 200 are arranged, that is, a direction parallel to the X-axis direction with respect to FIG. 1. The transfer pipe 420 may be disposed to be misaligned with the vent 201. For example, the transfer pipe 420 may be disposed to face a remaining area, excluding the areas in which the hoods 200 are disposed, from an entire area of the upper surface of the container 100.

The spray nozzle 430 extends from the transfer pipe 420 and is disposed to face the vent 201.

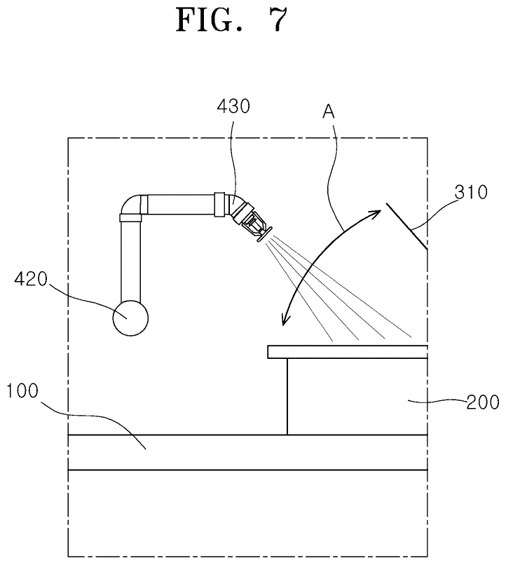

FIG. 7 is an enlarged view schematically illustrating a configuration of the spray nozzle according to some embodiments of the present disclosure.

Referring to FIG. 7, examples of the spray nozzle 430 according to some embodiments may include various types of nozzles that can spray the fire extinguishing liquid moving in the transfer pipe 420 to the outside of the transfer pipe 420.

The spray nozzle 430 may be disposed outside a rotation path A of the blocking panel 310. For example, the rotation path A of the blocking panel 310 may be a cylindrical trajectory formed by an area between the first broken end area 331 and the fixed portion 320 when the blocking panel 310 rotates.

For example, the spray nozzle 430 may be disposed to be spaced apart from the fixed portion 320 with the first broken end area 331 interposed therebetween. That is, the spray nozzle 430, the first broken end area 331, and the fixed portion 320 may be sequentially disposed from the transfer pipe 420 in a direction parallel to the Y-axis direction. In this case, the spray nozzle 430 may be disposed to face the inner surface of the blocking panel 310 when the vent 201 is opened.

A distance from the upper surface of the container 100 to the spray nozzle 430 may be greater than a distance from the upper surface of the container 100 to the upper end portion of the hood 200. That is, the spray nozzle 430 may be disposed at a higher position than the upper end portion of the hood 200. For example, an end portion of the spray nozzle 430 may extend to be inclined downward toward the vent 201 and may be disposed to face the vent 201 obliquely. For example, during the process for the blocking panel 310 to open the vent 201, the spray nozzle 430 may not be in direct contact with the blocking panel 310 and may guide the fire extinguishing liquid to be smoothly introduced into the vent 201.

The spray nozzle 430 may adjust a spray direction of the fire extinguishing liquid. For example, one end portion of the spray nozzle 430 disposed to face the vent 201 may be rotatably installed on the other end (e.g., an opposite end) portion of the spray nozzle 430 connected to the transfer pipe 420. One end portion of the spray nozzle 430 may be connected to a separate actuator, such as an electric motor or the like, and rotated by receiving a driving force from the actuator, thereby adjusting the spray direction of the fire extinguishing liquid. For example, the spray nozzle 430 may spray the fire extinguishing liquid over the entire area of the vent 201, and thus the efficiency of fire suppression may be further improved.

The spray nozzle 430 may be provided as a plurality of spray nozzles 430. The plurality of spray nozzles 430 may be formed in a number corresponding to the plurality of hoods 200. The plurality of spray nozzles 430 may be disposed to be spaced a set interval from each other in a longitudinal direction of the transfer pipe 420. The plurality of spray nozzles 430 may be disposed to face the respective vents 201.

Hereinafter, an operation of the energy storage system according to some embodiments of the present disclosure will be described.

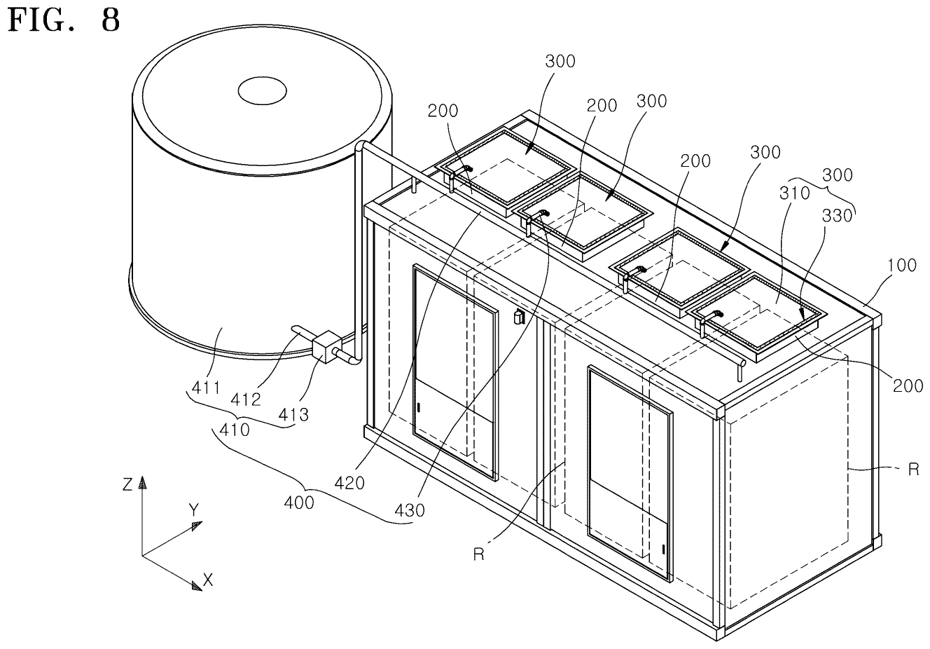

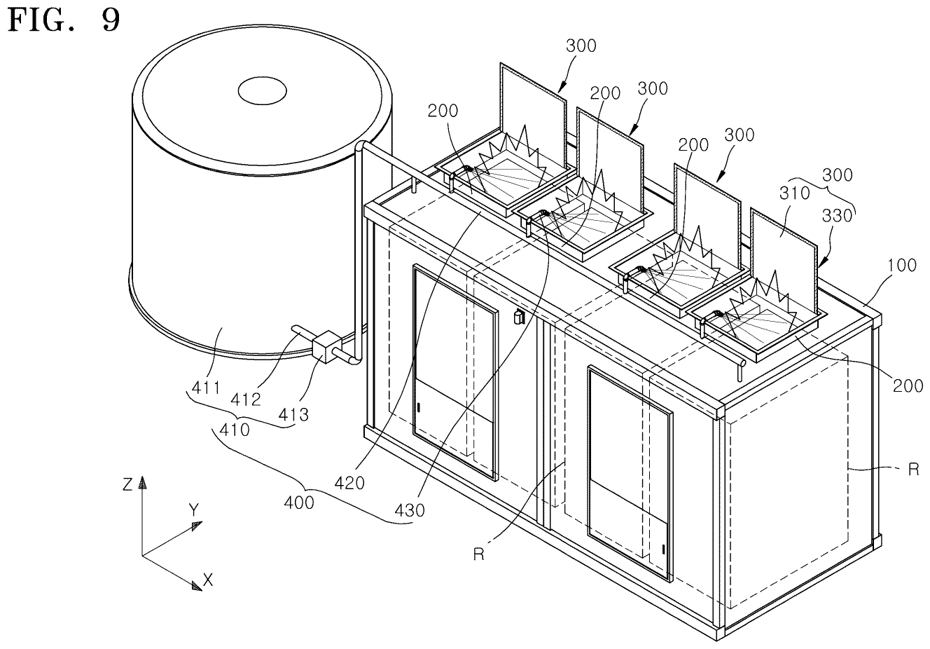

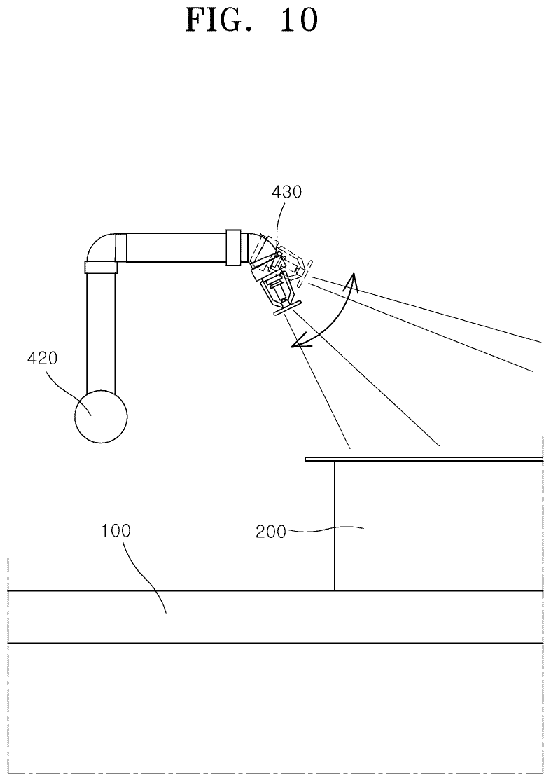

FIGS. 8 to 10 are views schematically illustrating an operation process of the energy storage system according to some embodiments of the present disclosure.

Referring to FIGS. 8 to 10, when the battery rack R is operating normally, the internal pressure of the container 100 is maintained at a set magnitude or less.

For example, the separated portion 330 is not separated from the hood 200, and the vent 201 may be maintained in a closed state.

Thereafter, if a fire occurs in the battery rack R, the air inside the container 100 is heated and an internal pressure of the container 100 increases.

When the internal pressure of the container 100 increases to a set magnitude, the separated portion 330 is separated from the hood 200.

The blocking panel 310 is rotated about the fixed portion 320 in the direction toward the outside of the container 100 and causes the vent 201 to be opened.

After the vent 201 is opened, the supply pipe 412 is opened by the worker's operation of the supply valve 413, and the fire extinguishing liquid stored in the storage tank 411 is transmitted to the transfer pipe 420 through the supply pipe 412.

The fire extinguishing liquid transmitted to the transfer pipe 420 is moved in the transfer pipe 420 and is introduced into the spray nozzle 430, and the spray nozzle 430 sprays the fire extinguishing liquid toward the vent 201.

The fire extinguishing liquid sprayed to the vent 201 is introduced into the internal space of the container 100 and extinguishes the fire in the battery rack R. In this process, the end portion of the spray nozzle 430 disposed to face the vent 201 may be rotated from its initial position, and may cause the spray direction of the fire extinguishing liquid to be able to be changed.

Hereinafter, an energy storage system according to some other embodiments of the present disclosure will be described.

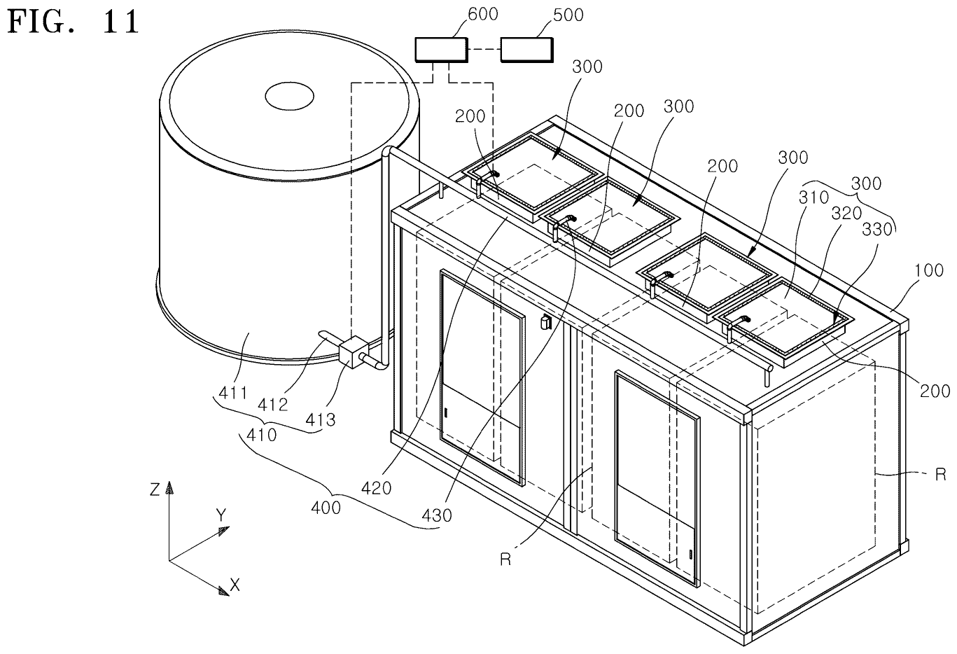

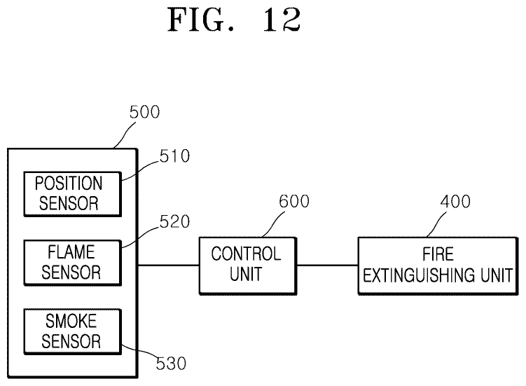

FIG. 11 is a perspective view schematically illustrating a configuration of the energy storage system according to some embodiments of the present disclosure, and FIG. 12 is a block diagram schematically illustrating the configuration of the energy storage system according to some embodiments of the present disclosure.

Referring to FIGS. 11 and 12, the energy storage system according to some embodiments may include a container 100, a hood 200, an opening/closing member 300, a fire extinguishing unit 400, a detection unit 500, and a control unit 600.

The energy storage system according to some other embodiments of the present disclosure may be configured to differ from the energy storage system according to some embodiments of the present disclosure previously described only in that a detection unit 500 and a control unit 600 are further included.

Accordingly, in describing the energy storage system according to some embodiments of the present disclosure, only the detection unit 500 and the control unit 600 that are not described in the energy storage system according to some embodiments of the present disclosure will be described.

The descriptions of the container 100, the hood 200, the opening/closing member 300, and the fire extinguishing unit 400 according to some embodiments of the present disclosure may be directly applied to the container 100, the hood 200, the opening/closing member 300, and the fire extinguishing unit 400 according to some other embodiments of the present disclosure.

In some embodiments, a supply valve 413 may be an electric valve that can automatically open or close a supply pipe 412 by a control signal input from the control unit 600, which will be described below, and a spray nozzle 430 may be an electric nozzle whose open or closed state can be automatically adjusted by a control signal input from the control unit 600.

The detection unit 500 detects the opening or closing of a vent 201. The detection unit 500 according to some embodiments may include at least one of a position sensor 510, a flame sensor 520, and a smoke sensor 530. In FIG. 12, the detection unit 500 is illustrated as including all of the position sensor 510, the flame sensor 520, and the smoke sensor 530, but the detection unit 500 is not limited thereto, and the detection unit 500 may include only any one of the position sensor 510, the flame sensor 520, and the smoke sensor 530, or only any two of the position sensor 510, the flame sensor 520, and the smoke sensor 530.

The position sensor 510 detects a position of the opening/closing member 300. The position sensor 510 according to some embodiments may include various types of position detection units, such as a rotation angle sensor that detects a rotation angle of a blocking panel 310, a camera that detects the movement of the blocking panel 310, an image sensor, etc. The position sensor 510 may be disposed outside the container 100. The position sensor 510 may be provided as a plurality of position sensors 510. The plurality of position sensors 510 may individually detect positions of a plurality of opening/closing members 300 that open or close respective vents 201.

The flame sensor 520 detects a flame discharged through the vent 201 when the vent 201 is opened. Examples of the flame sensor 520 according to some embodiments may include a thermal sensor, an infrared sensor, and the like that can detect temperature. The flame sensor 520 may be installed outside the container 100. The flame sensor 520 may be provided as a plurality of flame sensors 520. The plurality of flame sensors 520 may individually detect a flame discharged from the vents 201 formed in respective hoods 200.

The smoke sensor 530 detects smoke discharged through the vent 201 when the vent 201 is opened. Examples of the smoke sensor 530 according to some embodiments may include various types of smoke detection units that can detect smoke generated by combustion, such as an ionization smoke sensor, a photoelectric smoke sensor, etc. The smoke sensor 530 may be installed outside the container 100. The smoke sensor 530 may be provided as a plurality of smoke sensors 530. The plurality of smoke sensors 530 may individually detect smoke discharged from the vents 201 formed in the respective hoods 200.

The control unit 600 controls an operation of the fire extinguishing unit 400 on the basis of data detected by the detection unit 500. For example, the control unit 600 may determine whether the vent 201 is opened or closed on the basis of the data detected by the detection unit 500. When it is determined that the vent 201 is opened, the control unit 600 may operate the fire extinguishing unit 400. For example, the control unit 600 may operate the supply valve 413 and the spray nozzle 430, so that the fire extinguishing liquid is sprayed into the vent 201.

Further, the control unit 600 may individually determine whether the plurality of vents 201 are opened or closed on the basis of the data detected by the detection unit 500. The control unit 600 may control the operation of the fire extinguishing unit 400, for example, the supply valve 413 and the spray nozzle 430, so that the fire extinguishing liquid is sprayed only into a vent that is opened among the plurality of vents 201. Accordingly, the control unit 600 may prevent the fire extinguishing liquid from being sprayed into the unopen vents 201, resulting in unnecessary waste of the fire extinguishing liquid.

The control unit 600 may include an electronic control unit that monitors the data detected by the detection unit 500 in real time and controls the operation of the fire extinguishing unit 400 on the basis of the monitored data. Such an electronic control unit may control a plurality of hardware or software components by running an operating system or application, and may be implemented as an integrated circuit (IC), a microcontroller (μC), a microprocessor, an application specific integrated circuit (ASIC), etc., capable of performing various data processing and calculations, or a combination thereof.

Hereinafter, an operation of the energy storage system according to some embodiments of the present disclosure will be described.

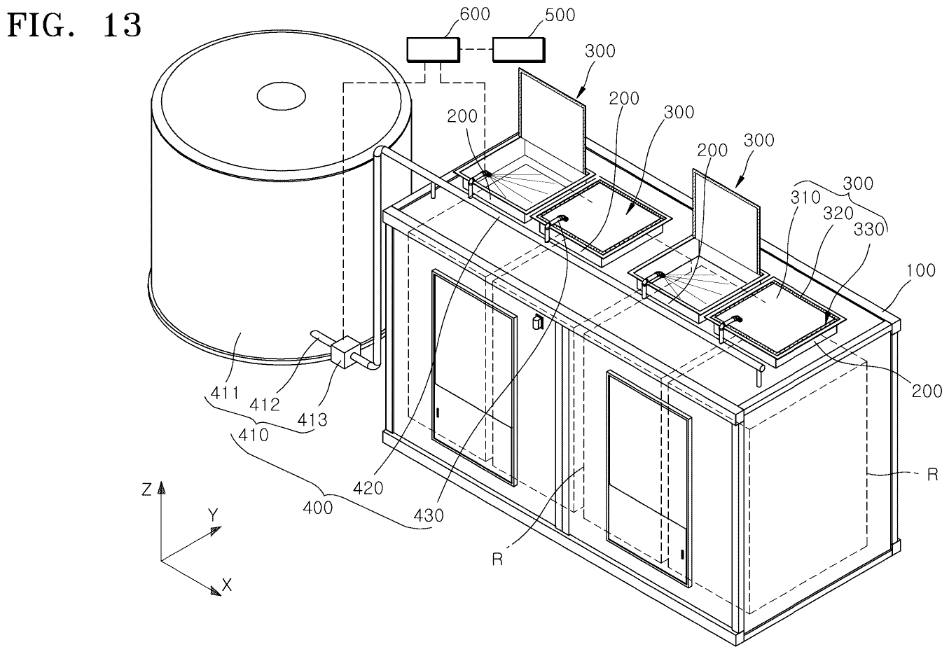

FIG. 13 is a view schematically illustrating an operation state of the energy storage system according to some embodiments of the present disclosure.

Referring to FIG. 13, if a fire occurs in the battery rack R, the air inside the container 100 is heated and the internal pressure of the container 100 increases.

In this process, only some of the plurality of vents 201 may be opened due to differences in pressure applied to the respective blocking panels 310.

The detection unit 500 individually detects the opening or closing of the plurality of vents 201. More specifically, the position sensor 510 may individually detect a rotation angle or movement of the plurality of blocking panels 310, and the flame sensor 520 and the smoke sensor 530 may individually detect the flame or smoke discharged from the plurality of vents 201.

The control unit 600 determines whether the plurality of vents 201 are opened or closed on the basis of the data detected by the detection unit 500.

When it is determined that any one of the plurality of vents 201 is opened, the control unit 600 may operate the supply valve 413 so that the supply pipe 412 is opened.

As the supply pipe 412 is opened, the fire extinguishing liquid stored in the storage tank 411 is transmitted to the transfer pipe 420 through the supply pipe 412.

Thereafter, the control unit 600 may open only the spray nozzle 430 disposed to face the vent/s 201 which is/are determined to be opened, among the plurality of vents 201, and may maintain the spray nozzle 430 disposed to face the vent/s 201 which is/are determined to be closed, in a closed state.

Accordingly, among the plurality of vents 201, only the spray nozzle 430 disposed to face the open vent 201 may spray the fire extinguishing liquid.

The fire extinguishing liquid sprayed into the vent 201 is introduced into an internal space of the container 100 and allows the fire in the battery rack R to be extinguished or substantially reduced. In this process, the end portion of the spray nozzle 430 disposed to face the vent 201 is rotated from its initial position, and causes the spray direction of the fire extinguishing liquid to be able to be changed.

According to the present disclosure, a fire extinguishing unit 400 is disposed on the outside of a container, and thus, it is possible to prevent or reduce damage to the fire extinguishing unit 400 caused by a flame or smoke generated inside the container and improve (e.g., increase) the reliability of fire suppression.

According to the present disclosure, a spray nozzle is disposed outside a rotation path of a blocking panel, and thus it is possible to prevent or substantially reduce a spray nozzle from directly interfering with a blocking panel and guide (e.g., allow) fire extinguishing liquid to be smoothly introduced into a vent during a process for the blocking panel to open the vent.

According to the present disclosure, a spray nozzle may spray a large amount of fire extinguishing liquid into a vent, and thus it is possible to perform effective fire suppression.

According to the present disclosure, a control unit operates a fire extinguishing unit so that fire extinguishing liquid may be sprayed only into a vent that is opened among a plurality of vents, and thus it is possible to prevent unnecessary waste of the fire extinguishing liquid.

However, the effects obtainable through the present disclosure are not limited to the above effects, and other technical effects that are not mentioned will be clearly understood by those skilled in the art from the following description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

Therefore, the technical scope of the present disclosure should be defined by the appended claims and their equivalents.

What is claimed is:

1. An energy storage system comprising:
a container configured to accommodate a battery rack;
a hood comprising a vent connected with an internal space of the container;
an opening/closing member that is installed in the hood and opens or closes the vent; and
a fire extinguishing unit outside the container that sprays a fire extinguishing liquid toward the vent as the opening/closing member opens the vent.

2. The energy storage system as claimed in claim 1, wherein the opening/closing member opens or closes the vent in response to an internal pressure of the container.

3. The energy storage system as claimed in claim 2, wherein the opening/closing member comprises:
a blocking panel disposed to block the vent;
a fixed portion that is on one side of the blocking panel and fixed to the hood; and
a separated portion that is on another side of the blocking panel and separably connected to the hood, and
wherein the separated portion is separated from the hood as a pressure of a preset magnitude or more is applied to the blocking panel.

4. The energy storage system as claimed in claim 3, wherein the fixed portion and the separated portion surround a perimeter of the blocking panel, and
wherein a length of the separated portion is longer than a length of the fixed portion.

5. The energy storage system as claimed in claim 3, wherein the blocking panel is rotated about the fixed portion as the separated portion is separated from the hood.

6. The energy storage system as claimed in claim 5, wherein the fire extinguishing unit comprises:
a supply unit that supplies fire extinguishing liquid;
a transfer pipe that is connected to the supply unit and transfers the fire extinguishing liquid supplied from the supply unit; and
a spray nozzle that extends from the transfer pipe and faces the vent.

7. The energy storage system as claimed in claim 6, wherein the hood and the spray nozzle are provided as a plurality of hoods and a plurality of spray nozzles, respectively, and
the plurality of spray nozzles face the plurality of hoods, respectively.

8. The energy storage system as claimed in claim 6, wherein the spray nozzle is outside a rotation path of the blocking panel.

9. The energy storage system as claimed in claim 8, wherein the separated portion comprises:
a first broken end area facing the fixed portion;
a second broken end area that is connected to one end portion of the fixed portion and one end portion of the first broken end area; and
a third broken end area that is connected to the other end portion of the fixed portion and the other end portion of the first broken end area, and
wherein the spray nozzle is spaced apart from the fixed portion with the first broken end area interposed therebetween.

10. The energy storage system as claimed in claim 8, wherein the spray nozzle faces an inner surface of the blocking panel when the blocking panel opens the vent.

11. The energy storage system as claimed in claim 8, wherein a distance from the container to the spray nozzle is greater than a distance from the container to an end portion of the hood, and the end portion of the spray nozzle extends obliquely toward the vent.

12. The energy storage system as claimed in claim 8, wherein the spray nozzle is provided to adjust a spray direction of the fire extinguishing liquid.

13. The energy storage system as claimed in claim 1, further comprising:
a detection unit configured to detect opening or closing of the vent; and
a control unit configured to determine whether the vent is opened or closed on the basis of data detected by the detection unit, and operate the fire extinguishing unit to spray the fire extinguishing liquid to the vent if it is determined that the vent is opened.

14. The energy storage system as claimed in claim 13, wherein the detection unit comprises at least one of the following:
a position sensor that detects a position of the opening/closing member;
a flame sensor that detects flame discharged from the vent; or
a smoke sensor that detects smoke discharged from the vent.

15. The energy storage system as claimed in claim 13, wherein the hood is provided as a plurality of hoods, and
the control unit individually determines whether a plurality of vents are opened or closed, and controls an operation of the fire extinguishing unit so that the fire extinguishing liquid is sprayed only to a vent that is opened among the plurality of vents.
